(19) United States
(12) Patent Application Publication
(10) Pub. No.: US 2014/0020713 A1
(43) Pub. Date: Jan. 23, 2014

(54) DRY-TYPE CLEANING CHASSIS, DRY-TYPE CLEANING DEVICE, AND DRY-TYPE CLEANING METHOD

(71) Applicants: Yuusuke TANEDA, Kanagawa (JP); Akihiro Fuchigami, Kanagawa (JP); Kohji Tsukahara, Kanagawa (JP); Kakuji Murakami, Kanagawa (JP); Shozo Murata, Kanagawa (JP)

(72) Inventors: Yuusuke TANEDA, Kanagawa (JP); Akihiro Fuchigami, Kanagawa (JP); Kohji Tsukahara, Kanagawa (JP); Kakuji Murakami, Kanagawa (JP); Shozo Murata, Kanagawa (JP)

(21) Appl. No.: 13/904,622

(22) Filed: May 29, 2013

(30) Foreign Application Priority Data
Jul. 23, 2012 (JP) 2012-162911
Dec. 27, 2012 (JP) 2012-285054

(51) Int. Cl. B08B 5/04; B08B 7/04

(52) U.S. Cl. CPC B08B 5/04; B08B 7/04
USPC 134/7; 15/302

(57) ABSTRACT

A dry-type cleaning chassis includes an internal space in which cleaning media are flown, an opening part configured to be in contact with a cleaning object, an air inlet duct configured to introduce external air into the internal space, a suction port that vacuums the air introduced into the internal space from the air inlet duct and causes a circulating air flow to be generated in the internal space, a flow path limiting member that regulates a circulating axis of the circulating air flow within the internal space, a cleaning media discharge outlet that is in communication with an exterior of a circulating flow path of the circulating air flow and is configured to discharge the cleaning media from the circulating flow path to the exterior, and a cleaning media guide member that guides the cleaning media to the cleaning media discharge outlet.

### BACKGROUND OF THE INVENTION

1. Field of the Invention

The present invention generally relates to a dry-type cleaning device that cleans a cleaning object by having flying cleaning media come into contact (e.g., collide) with the cleaning object. More particularly, the present invention relates to a dry-type cleaning device that is configured to be placed in contact with a given cleaning region of the cleaning object to clean this region, a dry-type cleaning chassis used in the dry-type cleaning device, and a dry-type cleaning method using the dry-type cleaning device.

For example, the present invention may be used to remove flux adhered to a so-called “dip pallet” or “carrier pallet,” which corresponds to a masking fixture used in a soldering process using a flow solder bath. Particularly, the present invention may be used to remove flux adhered to narrow areas such as the periphery of an opening or a side face of the cleaning object.

2. Description of the Related Art

Recently, fixtures for masking regions other than the regions where soldering is to be performed have been widely used in the soldering process using a flow solder bath. Such masking fixtures (a.k.a. dip pallets and carrier pallets), however, need to be periodically cleaned to prevent degradation of the masking accuracy due to the flux being accumulated on the surface of the masking fixtures.

Typically, such cleaning is performed by dipping the fixture into a solvent. In this case, a large amount of solvent is used thereby incurring high costs and imposing heavy burdens on the operator and the environment.

As an alternative to the above dipping method, a technique is known that involves spraying the solvent on the cleaning object within the cleaning device. However, in either case, a large amount of solvent is used to clean the cleaning object.

Japanese Laid-Open Patent Publication No. 2012-121017 discloses a dry-type cleaning device that has been developed in view of the above problem.

In the disclosed dry-type cleaning device, a suction unit is connected to a chassis having an internal space so that a negative pressure is generated within the chassis, and a circulating air flow is generated within the chassis by causing external air to enter the chassis at high speed from an air flow path arranged at a portion of an outer peripheral face of the chassis so that cleaning media that are arranged into sliced pieces (flakes) may be flown and circulated within the chassis by the circulating air flow.

The circulating air flow may be generated by placing an opening part of the chassis in contact with a cleaning object so that the cleaning object blocks the opening part. The opening has a cross-sectional area that is greater than the cross-sectional area of the air flow path formed at a portion of the outer peripheral face of the chassis. When the circulating air flow is generated, the cleaning media collide with the surface of the cleaning object at high speed at the opening part. By repeatedly causing such collision of the cleaning media, flux and other matter adhered to the surface of the cleaning object may be removed so that the cleaning object may be cleaned.

A porous separation plate is arranged between the internal space of the chassis and the suction unit so that matter removed from the cleaning object and the cleaning media that have been reduced to small pieces through friction, for example, may pass through the porous separation plate during cleaning operations to be collected at the suction unit side.

In the above dry-type cleaning device, the cleaning media are reduced to smaller pieces through degradation from the cleaning operations, and the cleaning media that become smaller than the size of the mesh holes of the separation plate are automatically discharged so that the cleaning capacity of the dry-type cleaning device may be maintained above a certain level.

In other words, the cleaning media with degraded cleaning capacity is discharged so that they may be prevented from accumulating within the circulating flow path and interfering with the cleaning operations of the cleaning media with higher cleaning capacity. In this way, the cleaning capacity of the dry-type cleaning device may be maintained at a certain level.

It is noted that in the dry-type cleaning device of the type described above, there may be a case where the type of cleaning media selected to be used according to the type of cleaning object is not suitable due to various conditions. In such case, after starting cleaning operations and monitoring the operations, if the cleaning efficiency does not reach a desired level, the cleaning media may have to be exchanged.

Also, there may be a case where the cleaning media cannot be smoothly discharged from the separation plate so that the cleaning capacity of the dry-type cleaning device may be degraded over time. In such a case, the cleaning media may have to be replaced by a new supply of cleaning media, for example.

To replace the cleaning media with new cleaning media, for example, in a configuration as illustrated in FIG. 16, used cleaning media 5 within a chassis 4 are vacuumed and collected at a dust collection duct 200 via an opening part 18 so that the used cleaning media 5 may be removed before introducing a new supply of cleaning media into the chassis 4.

In this case, cleaning operations are interrupted, and suction by the suction unit has to be halted while the dust collection duct 200 vacuums up the used cleaning media 5.

Unless suction by the suction unit is halted, a large amount of air may flow into the chassis 4 when the opening part 18 is moved away from the cleaning object and cause the used cleaning medium 5 to adhere to the separation plate 14 so that the used cleaning media 5 may not be effectively vacuumed and collected by the dust collection duct 200.

To restart the cleaning operations, after vacuuming up the used cleaning media 5, the new cleaning media have to be introduced by reactivating the suction unit and introducing the cleaning media via the opening part 18, or placing the opening part 18 in contact with the cleaning object and introducing the cleaning media via an inlet 24 that acts as an air flow path.

As can be appreciated, operations for exchanging the cleaning media are rather burdensome and affect the downtime of overall operations.

Also, in the above dry-type cleaning device, static electricity may be easily generated by the cleaning media that are flying at high-speed. In turn, when suction by the suction unit is stopped, the cleaning media may be adhered to the inner face of the chassis by the electrostatic force of the static electricity.

Although measures are implemented to vacuum up the cleaning media via the opening part in the above exchange method, a circulating air flow that is strong enough to remove the cleaning media adhered to the chassis by the electrostatic force is not generated so that complete removal of all the used cleaning media has been rather difficult.

Accordingly, in the above exchange method, exchange (replacement) of the cleaning media to new cleaning media may inevitably be incomplete.

### SUMMARY OF THE INVENTION

It is a general object of at least one embodiment of the present invention to provide a dry-type cleaning chassis, a dry-type cleaning device, and a dry-type cleaning method that substantially obviate one or more problems caused by the limitations and disadvantages of the related art. It is one specific object of at least one embodiment of the present invention to provide a dry-type cleaning chassis that enables exchange of cleaning media without interrupting cleaning operations in a simple and reliable manner to thereby improve working efficiency.

According to one embodiment of the present invention, a dry-type cleaning chassis is provided that is configured to clean a cleaning object by causing cleaning media to be flown by an air flow and causing the cleaning media to come into contact with the cleaning object. The dry-type cleaning chassis includes an internal space in which the cleaning media are flown, an opening part configured to be in contact with the cleaning object so that the cleaning media collide with the cleaning object, an air inlet duct configured to introduce external air into the internal space, a suction port that vacuums the air introduced into the internal space from the air inlet duct and causes a circulating air flow to be generated in the internal space, a flow path limiting member that regulates a circulating axis of the circulating air flow within the internal space, a cleaning media discharge outlet that is in communication with an exterior of a circulating flow path of the circulating air flow and is configured to discharge the cleaning media from the circulating flow path to the exterior, and a cleaning media guide member that guides the cleaning media to the cleaning media discharge outlet.

According to another embodiment of the present invention, a dry-type cleaning method is provided for cleaning a cleaning object. The dry-type cleaning method involves placing an opening part of a chassis in contact with the cleaning object to block the opening part and vacuuming air within the chassis, causing external air to flow into the chassis via an air inlet duct that is arranged at the chassis and causing a circulating air flow to be generated within the chassis, causing cleaning media that are flown by the circulating air flow within the chassis to collide with the cleaning object at the opening part, and discharging the cleaning media within the chassis during cleaning operations by blocking at least a portion of a circulating flow path of the circulating air flow with a cleaning media guide member and guiding the cleaning media to a cleaning media discharge outlet that is in communication with an exterior of the circulating flow path and is configured to discharge the cleaning media from the circulating flow path.

According to an aspect of the present invention, cleaning media exchange operations are performed when the cleaning media are not electrostatically adhered to the chassis. That is, energy of the cleaning media flown by a circulating air flow during cleaning operations is used to exchange the cleaning media. In this way, cleaning media may be quickly exchanged in a simple and reliable manner without stopping cleaning operations.

In turn, downtime caused by the cleaning media exchange operations may be reduced, working efficiency of the cleaning operations may be improved, and the required labor for exchanging the cleaning media may be reduced, for example.

### BRIEF DESCRIPTION OF THE DRAWINGS

Other objects and further features of embodiments will be apparent from the following detailed descriptions when read in conjunction with the accompanying drawings, in which:

FIG. 1 is a cross-sectional view of a dry-type cleaning chassis according to a first embodiment of the present invention in which a cleaning media guide member is arranged at a discharge position;

FIG. 2 is a perspective view of the dry-type cleaning chassis of the first embodiment with the cleaning media guide member arranged at the discharge position;

FIG. 3 is a cross-sectional view illustrating cleaning media being discharged;

FIG. 4 is a cross-sectional view of the dry-type cleaning chassis of the first embodiment in which the cleaning medium guide member is arranged at an open position;

FIG. 5 is a perspective view of the dry-type cleaning chassis of the first embodiment with the cleaning media guide member arranged at the open position;

FIG. 6 is an exploded perspective view of the dry-type cleaning chassis of the first embodiment;

FIG. 7 is a cross-sectional view illustrating a flow of air being vacuumed toward a suction port of the dry-type cleaning chassis of the first embodiment;

FIG. 8 is a cross-sectional view illustrating an exemplary operation in which the cleaning media guide member is adjusted to the open position and cleaning media are vacuumed into the dry-type cleaning chassis of the first embodiment;

FIG. 9 is a cross-sectional view illustrating an exemplary operation in which the cleaning media guide member is adjusted to the discharge position and cleaning media are discharged from the dry-type cleaning chassis of the first embodiment;

FIG. 10 is a graph indicating experimental results obtained from comparing conventional cleaning media discharge operations and cleaning media discharge operations according to an embodiment of the present invention;

FIG. 11 is a cross-sectional view of a dry-type cleaning chassis according to a second embodiment of the present invention;

FIGS. 12A and 12B are cross-sectional views of a dry-type cleaning chassis according to a third embodiment of the present invention;

FIGS. 13A and 13B are cross-sectional views of a dry-type cleaning device that is used as a basis of the present invention;

FIGS. 14A and 14B are cross-sectional views illustrating basic operations of the dry-type cleaning device;

FIG. 15 is a perspective view illustrating an exemplary manner of using the dry-type cleaning device; and

FIG. 16 is a cross-sectional view illustrating conventional discharge operations for discharging cleaning media.

### DESCRIPTION OF THE PREFERRED EMBODIMENTS

In the following, definitions are provided for certain terms and expressions used in the descriptions below.

The term “chassis” used herein refers to a container-like structure having a space where a circulating air flow is likely to be generated. The term “space where a circulating air flow is likely to be generated” refers to a space having a shape including a continuous inner surface so that air can circulate along the inner surface of the space. More preferably, the space has a shape including a rotating-body-shaped inner surface or inner space.

The term “air flow path” used herein refers to a unit that allows air to flow in a certain direction and typically has a tube shape and a smooth inner surface. Further, the “air flow path” may also refer to a path formed by using a plate-like path limiting plate having a smooth surface when air can flow along the surface and air flowing direction is determined.

In addition to a general case where air flows linearly, in a case where air flows in a gentle curve having a low flow path resistance, a certain air flowing direction may also be determined. However, unless otherwise described, the term “direction of the air flow path” refers to the direction of air flow blowing out at an air flow inlet. Further, herein, the air flow path having a straight tube shape, having one end connected to the air flow inlet, and having another end as an air taking inlet open to the atmosphere of the outside of the chassis may refer to an “inlet”. Generally, the inlet includes a smooth inner surface having a low fluid resistance and has a circular, rectangular, or slit-shaped shape to be cross section.

Further, herein, the term “circulating air flow” refers to a flow accelerated at the position of the air flow inlet by an incoming flow and flowing by changing the flowing direction along the inner surface of the chassis, returns to the position of the air flow inlet, and joins with the incoming flow. Generally, the circulating air flow may be generated by flowing (introducing) air in the tangential direction of the inner wall in a closed space having a continuous (endless) inner wall.

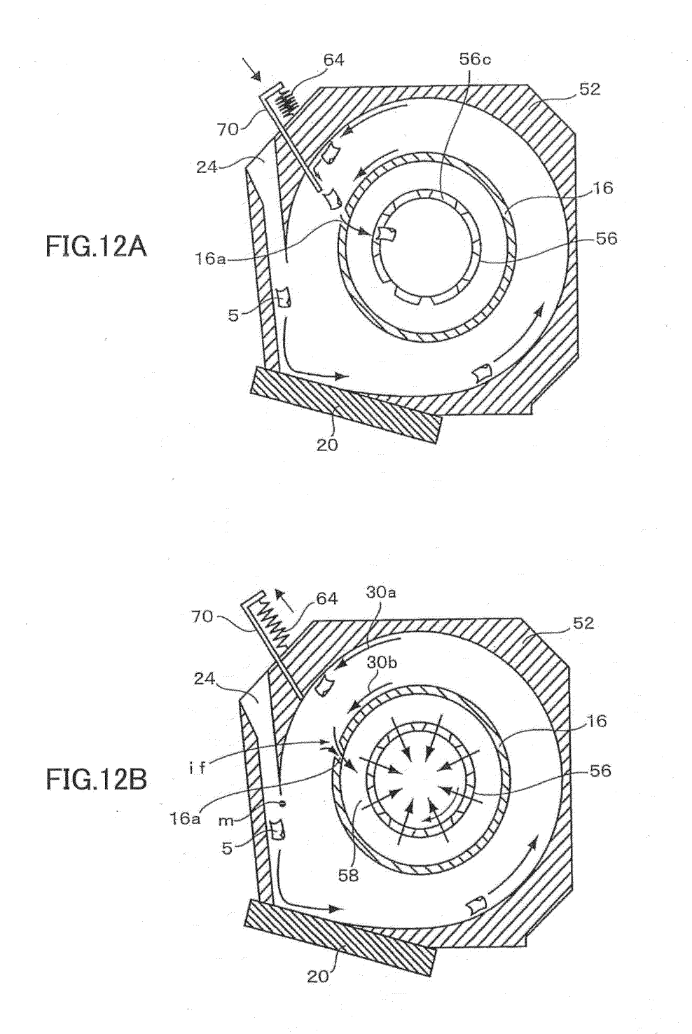

In the following, embodiments of the present invention are described with reference to the accompanying drawings. FIGS. 1-10 illustrate a first embodiment of the present invention; FIG. 11 illustrates a second embodiment of the present invention; and FIGS. 12A and 12B illustrate a third embodiment of the present invention.

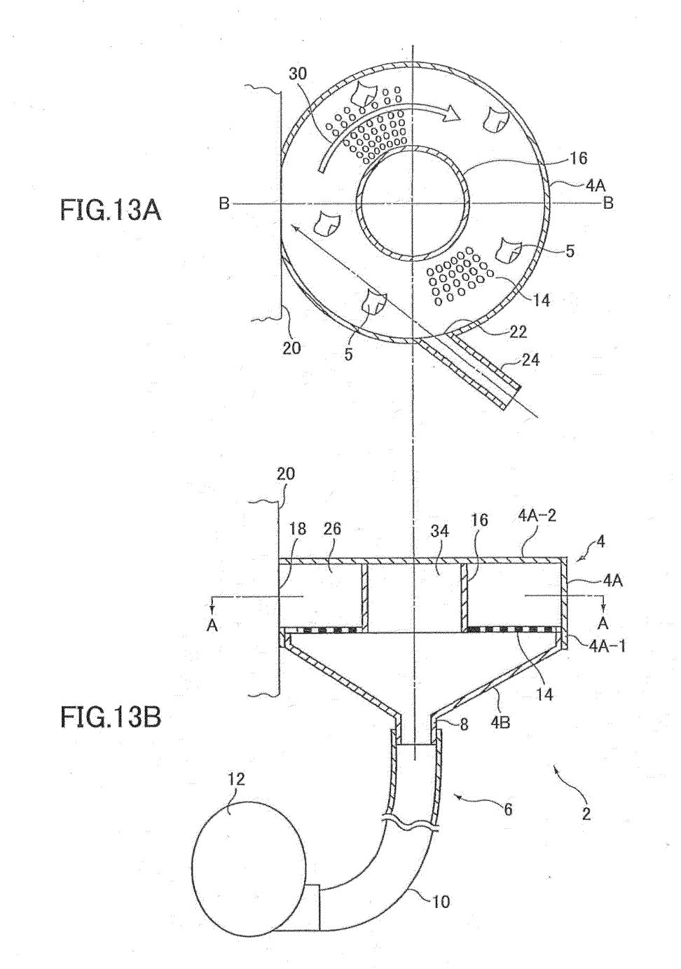

Before describing specific preferred embodiments of the present invention, a basic configuration and basic operations of a dry-type cleaning device are described with reference to FIGS. 13A through 15.

FIGS. 13A and 13B illustrate a configuration of a handy-type dry-type cleaning device 2 that is used as a basis of the present invention. FIG. 13A is a horizontal cross-sectional view cut along cutting plane line A-A of FIG. 13B, and FIG. 13B is a vertical cross-sectional view cut along cutting plane line B-B of FIG. 13A.

As illustrated in FIGS. 13A and 13B, the dry-type cleaning device 2 includes a dry-type cleaning chassis (simply referred to as “chassis” hereinafter) 4 having a flying space (space) for cleaning media 5 and a suction unit 6 that generates a negative pressure in the chassis 4. The chassis 4 includes an upper chassis 4A having a cylindrical shape and a lower chassis 4B having an inverted conical shape. The upper chassis 4A and the lower chassis 4B are integrated with each other to constitute the chassis 4. It is noted that although referred to as “upper” and “lower” for explanatory purposes in view of their positional relationship in the drawings, in practical applications, the upper chassis 4A and the lower chassis 4B are not confined to such positional relationship.

As illustrated in FIG. 13A, a suction port 8 is integrally connected to the top of the conical shape of the lower chassis 4B so as to function as a suction duct. As illustrated in FIG. 13B, the suction unit 6 includes a suction hose 10 and a suction device 12. One end of the suction hose 10 is connected to the suction port 8, and the other end of the suction hose 10 is connected to the suction device 12. As the suction device 12, a vacuum cleaner for domestic use, a vacuum motor, a vacuum pump, or a device indirectly generating a low pressure or a negative pressure by pumping liquid may be used. In the following descriptions, terms such as “upper surface” and “bottom surface” are used only for the purpose of identifying the corresponding elements in the drawings and are not to be construed to limit the positions of these corresponding elements in actual applications.

Referring back to FIG. 13B, the upper chassis 4A includes an engage concave part 4A-1 at the bottom surface part of the upper chassis 4A. The engage concave part 4A-1 is detachably engaged with the upper end part of the lower chassis 4B. The upper surface 4A-2 of the upper chassis 4A is sealed. In a boundary area between the upper chassis 4A and the lower chassis 4B at the bottom surface part of the upper chassis 4A, a porous separation plate 14 is provided as a porous unit. The separation plate 14 is a plate member having holes of a punched metal. The separation plate 14 hinders movement of the cleaning media 5 when the cleaning media 5 is attracted toward the lower chassis 4B side by suction. It is noted that in FIG. 13A, illustration of some parts of the separation plate 14 is omitted, and the cleaning media 5 is enlarged for explanatory purposes.

As the porous unit, any appropriate porous matter may be used as long as the porous matter can block the cleaning media 5 but let air and dust (i.e., matter removed from the cleaning object) pass therethrough. For example, a slit plate, a net or the like may be used. Further, as the material of the porous unit, any appropriate material may be used as long as the material has a smooth surface. For example, the material of the porous unit may be selected from resins, metals, and the like.

The porous unit is disposed so that the surface of the porous unit is substantially orthogonal to the central axis of the circulating air flow. In this way, air may flow along the surface of the porous unit so that stagnation of the cleaning media 5 at the porous unit may be prevented.

To reduce the attenuation of the circulating air flow and the stagnation of the cleaning media 5, the inner surface of the chassis is preferably arranged to be flat and smooth without unevenness.

By disposing the porous unit along the surface substantially parallel to the direction of the circulating air flow, the cleaning media 5 that are adhered to the surface of the porous unit may be removed from the surface and flown again.

Although the material of the chassis 4 is not limited to a specific material, a metal such as aluminum, stainless or the like may preferably be used to reduce adhesion of foreign matter and wear caused by friction with the cleaning media. However, a material made of resin may also be used as long as the material has adequate durability against friction, for example.

In the center part in the upper chassis 4A, a flow path limiting member 16 having a cylindrical shape is provided as a part of the chassis 4. The flow path limiting member 16 has the same cylindrical axis as that of the upper chassis 4A. Further, the lower end of the flow path limiting member 16 is fixed to the separation plate 14.

The flow path limiting member 16 is arranged in order to reduce the cross-sectional area of the flow path of the circulating air flow so as to increase the flow speed of the circulating air flow. By arranging the flow path limiting member 16, a ring-shaped circulating air flow moving space (cleaning medium flying space) is formed that allows the circulating air flow to flow (move) therein. It is noted that in the following descriptions, the ring-shaped circulating air flow moving space may also be referred to as “circulating flow path”. The flow path limiting member 16 also acts as a member regulating the circulating axis of the circulating air flow.

It is noted that the central axis (cylindrical axis) of the flow path limiting member 16 does not necessarily have to be coaxial with the central axis of the upper chassis 4A. That is, the central axis (cylindrical axis) of the flow path limiting member 16 may be different from that of the upper chassis 4A as long as a ring-shaped space can be created.

Further, an opening part 18 is formed at one part of the side surface of the upper chassis 4A. The opening part 18 is provided so that the cleaning media 5 flown by the circulating air flow can come into contact with or collide with a cleaning object 20 that is held against the opening part 18.

The upper chassis 4A has a cylindrical shape with a small height with respect to its diameter. The opening part 18 is arranged at a part of the side face of upper chassis 4A forming the height of the cylindrical shape.

Referring to FIG. 13B illustrating the overall configuration of the chassis 4, by arranging the opening part 18 in the manner described above, the outer circumferential part of the chassis 4 other than the opening part 18 may be away (separated) from the cleaning object 20. In this way, the degree of freedom of local contact with the cleaning object 20 (i.e., pinpoint cleaning) may be increased.

The opening part 18 has the shape of a flat cross-sectional face of the side face of the upper chassis 4A across a section parallel to the cylindrical axis of the upper chassis 4A. When viewed from the direction orthogonal to the cylindrical axis, the shape of the opening part 18 is rectangular.

Further, an air intake port 22 is formed at another part of the side surface of the upper chassis 4A. The air intake port 22 is connected to an inlet (i.e., air inlet duct) 24, which acts as a circulating air flow generation unit and a ventilation path. The inlet 24 is connected to the upper chassis 4A from the external side and is integrally fixed to the upper chassis 4A so that external air can be introduced into the upper chassis 4A through the inlet 24 and the air intake port 22.

The inlet 24 is arranged to be substantially parallel to the separation plate 14, and its ventilation direction (air flow direction or central axis) is arranged to be inclined with respect to the radial direction of the upper chassis 4A so that when the central axis of the inlet 24 is extended, the extended central axis of the inlet 24 reaches the opening part 18.

The inlet 24 has a width extending in the height direction of the upper chassis 4A. In one embodiment, one inlet 24 having a diameter or width less than the height of the upper chassis 4A may be provided. Alternatively, plural units of the inlet 24 may be arranged in the height direction of the upper chassis 4A.

As illustrated in FIGS. 13A and 13B, when the opening part 18 comes into contact with the cleaning object 20 to be sealed by the cleaning object 20, the internal space within the chassis 4 turns into a closed space, external air flows into the chassis 4 from the inlet 24 at high speed, and the high speed air flow accelerates the cleaning media 5 to move toward the opening part 18 and generates a circulating air flow 30.

The circulating air flow 30 that is generated when the closed space is formed blows off the cleaning media 5 adhered to the separation plate 14 and causes the cleaning media 5 to fly once again.

The size of the opening part 18 is arranged to be adequately large so that when the opening part 18 is released (i.e., when the opening part 18 is separated from the cleaning object 20), the internal pressure at the air intake port 22 becomes substantially equal to atmospheric pressure. Also, the air intake port 22 is arranged at a suitable position at which its internal pressure may be easily adjusted to a pressure value substantially equal to the atmospheric pressure when the opening part 18 is released.

By implementing the configuration as described above, when the dry-type cleaning device 2 is not in contact with the cleaning object 20, the internal pressure at the air intake port 22 becomes substantially equal to atmospheric pressure so that the differential pressure between the internal pressure and the external pressure is reduced. As a result, the amount of air flowing into the upper chassis 4A through the opening of the opening part 18 is remarkably reduced. On the other hand, the amount of air flowing into the upper chassis 4A is increased. As a result, leakage of the cleaning media 5 from the chassis 4 may be prevented.

Further, the amount of air flow while the opening part 18 is released may be two to three times greater than the amount of air flow while the opening part 18 is sealed. Therefore, while the opening part 18 is released, the cleaning media 5 that are arranged into flakes may be adhered to the porous unit (separation plate 14) so that the cleaning media 5 would not fly and leak outside the chassis 4. Such an effect that occurs when the opening part 18 is released is referred to as “cleaning media suction effect.”

The cleaning media 5 may refer to a set of cleaning media flakes corresponding to sliced pieces of cleaning media. The cleaning media 5 may also refer to a single piece of the cleaning media.

A single piece (flake) of the cleaning media may have an area greater than or equal to 1 mm² but less than or equal to 200 mm², for example. The material of the cleaning medium 5 may be a film having durability such as polycarbonate, polyethyleneterephthalate, acryl, cellulose resin and the like. The thickness of the cleaning media 5 may be greater than or equal to 0.02 mm but less than or equal to 1.0 mm. However, the thickness, size, and material of the cleaning media 5 may preferably be modified depending on the cleaning object 20. Thus, the cleaning media used in the present invention is not limited to a particular thickness, size, or material, and any of the various kinds of the cleaning media may be used. For example, the material of the cleaning media is not limited to resin, but any material that could be arranged into thin and lightweight pieces that could easily be blown may be used such as flakes of paper, cloth, minerals such as mica, ceramics, glass, and metallic foils.

The upper chassis 4A has a ring-shaped internal space 26 where the cleaning media 5 is blown by the circulating air flow so that the cleaning media 5 come into contact with the cleaning object 20 facing the opening part 18. On the other hand, there is no circulating air flow in an internal space 34 of the flow path limiting member 16.

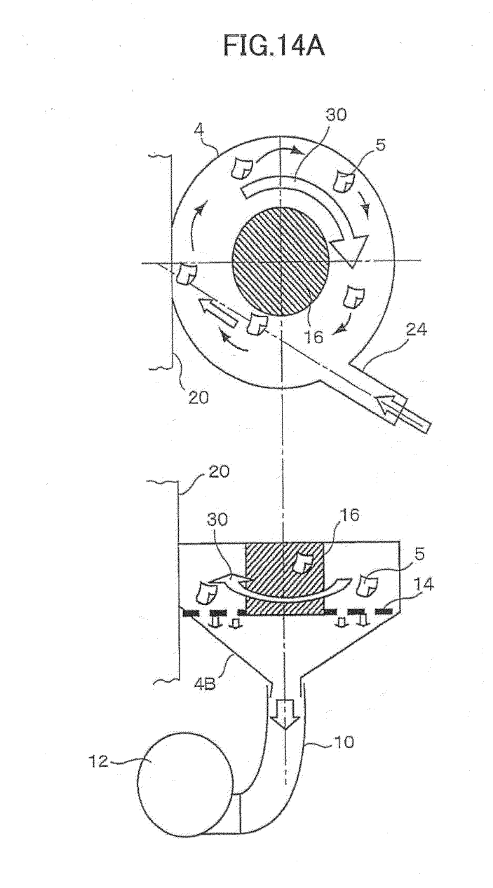

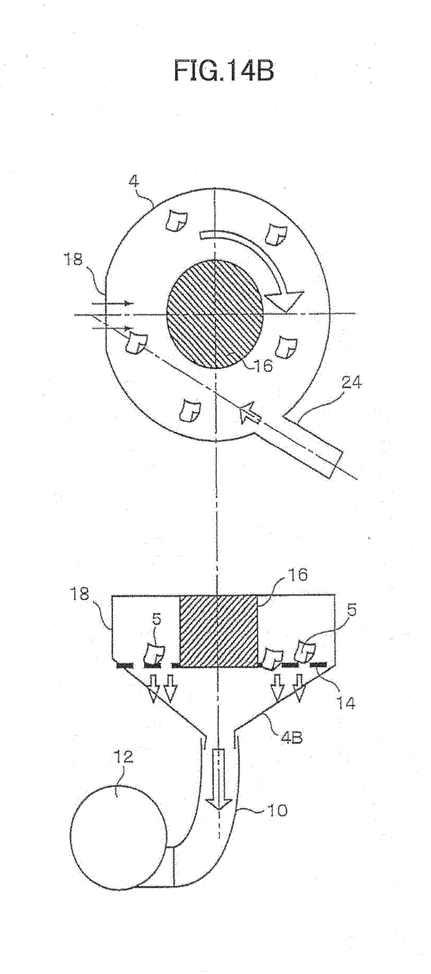

Next, cleaning operations performed by the dry-type cleaning device 2 having the above configuration are described with reference to FIGS. 14A and 14B. It is noted that in FIGS. 14A and 14B, certain features such as the thickness dimensions of the various elements are omitted for the sake of simplifying the illustrations, and the internal space 34 corresponding to a static space is represented by hatchings to facilitate its identification.

FIG. 14B illustrates a case where the opening part 18 is separated from the cleaning object 20 so that air is suctioned while the opening part 18 is released. On the other hand, FIG. 14A illustrates a case where the opening part 18 is held in contact with the cleaning object 20 and is sealed by the cleaning object 20.

Before starting the cleaning operations, the cleaning media 5 are supplied to the chassis 4. The cleaning media 5 supplied to the chassis 4 are adhered to the separation plate 14 as illustrated in FIG. 14B and retained within the chassis 4.

Because a negative pressure is generated in the chassis 4 by suction, air outside the chassis 4 flows into the chassis 4 through the inlet 24. However, the air flows in through the inlet 24 at a relatively low speed and at a relatively low rate. Thus, the circulating air flow 30 generated in the chassis 4 may not be strong enough to blow off the cleaning media 5 adhered to the separation plate 14.

After the cleaning media 5 are supplied to the chassis 4, the opening part 18 is held in contact with a region to be cleaned on the surface of the cleaning object 20 and is sealed as illustrated in FIG. 14A.

When the opening part 18 is sealed, the air flow from the opening part 18 by suction is stopped. As a result, the negative pressure in the chassis 4 is rapidly increased, and both the amount and the flow rate of air suctioned through the inlet 24 are increased. Then, the air flow defined by the inlet 24 flows out from the output port of the inlet (i.e., the air intake port 22) into the chassis as a high-speed air flow.

The air flowing out from the air intake port 22 blows the cleaning media 5 on the separation plate 14 are toward the surface of the cleaning object 20 facing the opening part 18.

A part of the above air flow becomes the circulating air flow 30 flowing along the inner wall of the chassis 4 to form a ring-like air flow while another part of the air flow passes through the holes of the separation plate 14 by suction of the suction unit 6.

When the circulating air flow 30 flowing in the chassis 4 in a ring-shape described above returns to the position near the air intake port 22 of the inlet 24, the circulating air flow 30 is combined with and accelerated by the air flow from the inlet 24. In this way, the circulating air flow 30 may be stably generated in the chassis 4.

The cleaning media 5 are circulated in the chassis 4 by the circulating air flow 30, so that the cleaning media 5 may repeatedly collide with the surface of the cleaning object 20. Due to the impact by the collision, dust on the surface of the cleaning object 20 may be separated from the surface in the form of fine particles or powder.

The separated dust particles are discharged outside of the chassis 4 through the holes of the separation plate 14 by suction of the suction unit 6.

The rotational axis of the circulating air flow 30 generated in the chassis 4 is orthogonal to the surface of the separation plate 14. Therefore, the circulating air flow 30 is flowing in the direction substantially parallel to the surface of the separation plate 14.

Therefore, the circulating air flow 30 blows the cleaning media 5 adhered to the separation plate 14 in the lateral direction and flows between the cleaning media 5 and the separation plate 14, so as to blow off the cleaning media 5 from the separation plate 14 to have the cleaning media 5 fly again.

Further, when the opening part 18 is sealed, the negative pressure in the upper chassis 4A is increased to be close to the negative pressure in the lower chassis 4B. Therefore, the suction force attracting the cleaning media 5 to the surface of the separation plate 14 may be reduced, which may facilitate flying of the cleaning media 5.

Because the circulating air flow 30 has air flow accelerated in a certain direction, a fast air flow may be easily generated, and in turn, a fast flying movement of the cleaning media 5 may be facilitated. While the cleaning media 5 are circulated at high speed, the cleaning media 5 are less likely to be attracted to the separation plate 14, and dust particles attached to the cleaning media 5 are likely to be separated from the cleaning media 5 due to the centrifugal force applied to the dust particles.

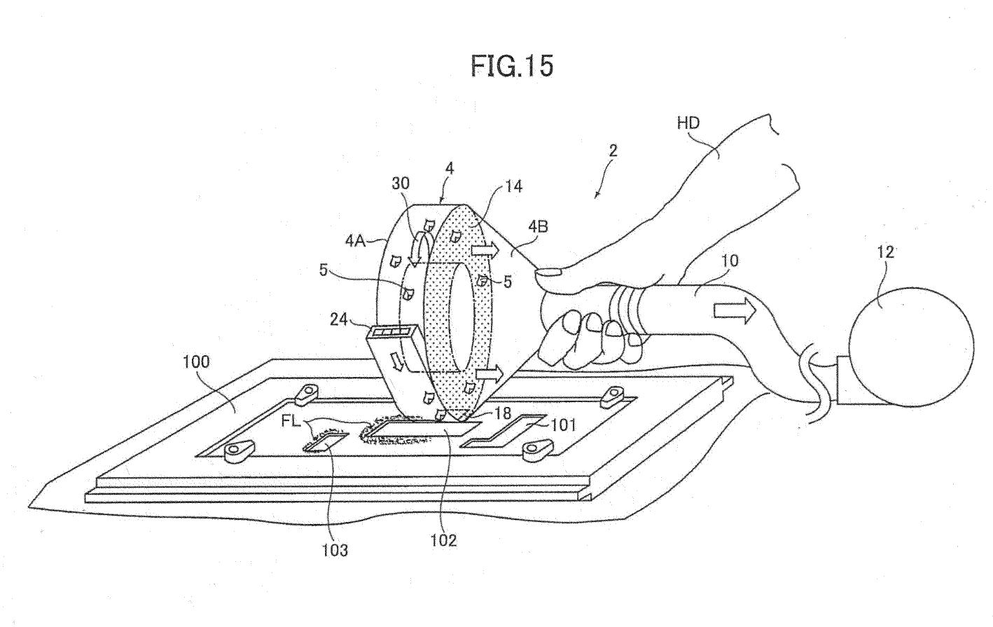

FIG. 15 illustrates a case where the dry-type cleaning device 2 described above is actually used.

In this example, the cleaning object corresponds to a dip palette 100 that is used in a process of a flow solder bath, and the dry-type cleaning device 2 removes flux accumulated near mask opening parts 101 through 103 of the dip pallet 100.

That is, flux is accumulated and adhered to the periphery of the mask opening parts 101 through 103, and the dry-type cleaning device 2 removes the accumulated flux as the dust particles to be removed.

As illustrated in FIG. 15, the base portion near the suction port 8 is held by a hand HD. Then, while air is suctioned by the suction device 12, the opening part 18 of the chassis 4 is pressed against a cleaning region.

Before the opening part 18 is pressed against the cleaning region, air in the chassis 4 is suctioned and the cleaning media 5 are adhered to the separation plate 14. Therefore, even when the opening part 18 faces downward, the cleaning media 5 are prevented from leaking out of the chassis 4.

Moreover, after the opening part 18 is pressed against the cleaning region, the interior of the chassis 4 may be sealed so that no cleaning media 5 may leak out.

When the opening part 18 is pressed against the cleaning region, the amount of air flowing through the inlet 24 is remarkably increased. As a result, a strong circulating air flow 30 is generated. The air flowing into the chassis 4 blows off the cleaning media 5 adhered to the separation plate 14, so that the cleaning media 5 can collide with the flux FL adhered and fixed to the cleaning region of the dip palette 100 to remove the flux FL.

A cleaning operator may hold the base portion near the suction port 8 with his/her hand HD and move the position of the cleaning device 2 relative to the dip pallet 100 so as to sequentially move the cleaning device 2 along the cleaning region to remove all the flux FL adhered and fixed to the cleaning region.

In the example illustrated in FIG. 15, the peripheral region of the mask opening part 101 of the dip pallet 100 has been cleaned, and the peripheral regions of the mask opening parts 102 and 103 have not yet been cleaned.

During the cleaning operations, even when the opening part 18 is separated from the cleaning region while being moved relative to the cleaning region, the cleaning media 5 are unlikely to be leaked from the chassis 4 owing to the cleaning media suction effect described above. In this way, the amount of the cleaning media 5 in the chassis 4 may be prevented from substantially decreasing and degradation of the cleaning performance due to such a decrease in the amount of cleaning media may be prevented.

The cleaning media 5, however, may be gradually damaged through repeated collision with the cleaning object 20, for example. In this case, the damaged cleaning media 5 may be collected by the suction device 12 along with the flux FL (dust) removed from the dip pallet 100. Therefore, the amount of the cleaning media 5 in the chassis 4 may gradually decrease as the dry-type cleaning device 2 continues to be used for a long period of time.

In such a case, additional cleaning media 5 may be supplied into the chassis 4.

In the following, a dry-type cleaning chassis 50 according to a first embodiment of the present invention is described with reference to FIGS. 1 through 10. It is noted that in the following descriptions of preferred embodiments of the present invention, the same reference numerals may be used to identify elements substantially identical to or corresponding to the elements of the configuration described above, and their descriptions may be omitted.

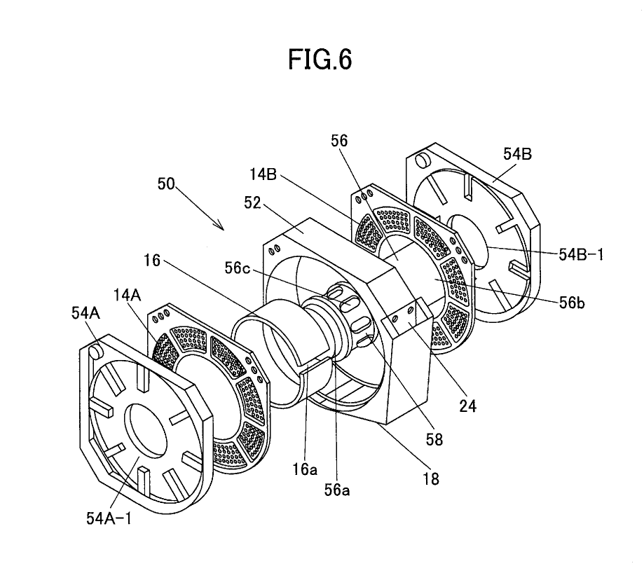

As illustrated in FIG. 6, the dry-type cleaning chassis 50 of the first embodiment includes a chassis body 52 having a through hole extending in the circulating axis direction, a cylindrically-shaped flow path limiting member 16 that is arranged at the center part of the through hole of the chassis body 52, separation plates 14A and 14B fixed at opposite sides of the chassis body 52 with respect to the circulating axis direction, outer covers 54A and 54B respectively covering the outer sides of the separation plates 14A and 14B, and a dust collection duct 56 that has a dual-cylinder structure and is arranged at the interior of the flow path limiting member 16, for example.

A first end part 56a of the dust collection duct 56 is sealed, and this first end part 56a is inserted into a center hole 54A-1 of the outer cover 54A. A second end part 56b of the dust collection duct 56 corresponds to a suction port. This second end part (suction port) 56b is inserted through a center hole 54B-1 of the outer cover 54B and is connected to the suction unit 6.

The flow path limiting member 16 includes a cleaning media discharge outlet 16a for discharging cleaning media 5 as is necessary or desired. Plural air suction holes 56c are formed along the peripheral direction at a portion of the dust collection duct 56 near the first end part 56a corresponding to the position of the cleaning media discharge outlet 16a. Also, a cleaning media guide member 58 for guiding the cleaning media 5 toward the cleaning media discharge outlet 16a is arranged at the portion of the dust collection duct 56 where the air suction holes 56c are formed.

The inlet 24 corresponding to an air inlet duct is formed at an upper part of one side of the chassis body 52, and the opening part 18 is formed at a lower part of the side of the chassis 52 below the inlet 24.

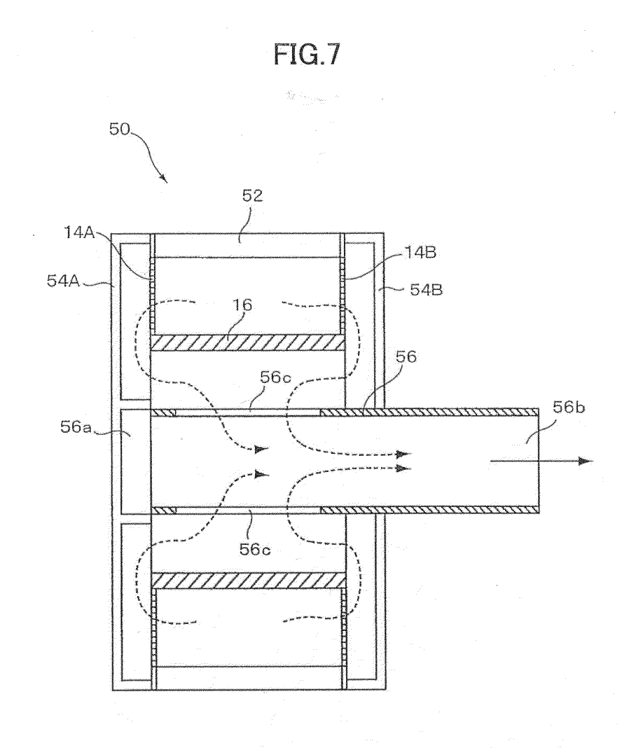

As illustrated in FIG. 7, the dust collection duct 56 is arranged at the interior of the flow path limiting member 16, and the internal space of the flow path limiting member 16 is in communication with the suction port 56b. While in operation, air flowing in from the inlet 24 flows around a circulating flow path 60 (see FIG. 1) and passes the separation plate 14A/14B, the inner side of the flow path limiting member 16, and the space within the dust collection duct 56, to be discharged from the suction port 56b to the suction unit 6.

When the cleaning media 5 are stored inside the chassis 50 and the opening part 18 is moved away (separated) from the cleaning object 20, the cleaning media 5 adhere to the separation plate 14A/14B by suction to be retained within the chassis 50.

The size of the cleaning media discharge outlet 16a, which connects the circulating flow path 60 to the interior of the flow path limiting member 16; i.e., connects the circulating flow path 60 to the exterior, is arranged so that the cleaning media 5 can pass therethrough.

The shape of the cleaning media discharge outlet 16a is not particularly limited as long as it enables the cleaning media 5 to pass therethrough. However, from a design efficiency perspective, the cleaning media discharge outlet 16a may preferably be arranged into a round hole, a long hole, or a rectangular hole, for example. Also, the size of the cleaning media discharge outlet 16a may preferably be arranged to be one to several times greater than the size of the cleaning media 5.

Because the air suction hole 56c of the dust collection duct 56 acts as a member for passing the cleaning media 5 and vacuuming the cleaning media 5, the size of the air suction hole 56c may preferably be greater than the size of the cleaning media discharge outlet 16a.

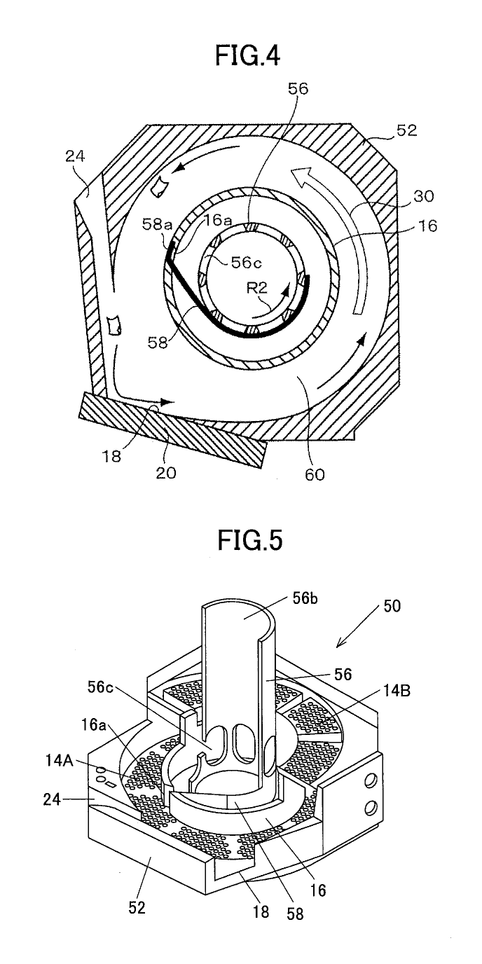

The cleaning media guide member 58 is a band member made of an elastic material. As illustrated in FIG. 4, a base part of the cleaning media guide member 58 is fixed to the outer peripheral face of the dust collection duct 56, and the cleaning media guide member 58 may be moved in and out of the cleaning media discharge outlet 16a. The width of the cleaning media guide member 58 in the circulating axis direction is arranged to be an adequate width for blocking a cross-section of the circulating flow path 60. The dust collection duct 56 acts as a rotatable inner cylinder (rotatable member) that may be rotated to enable the cleaning media guide member 58 to move in and out of the cleaning media discharge outlet 16a.

A tip part (free end part) 58a of the cleaning media guide member 58 is bent to extend along the outer periphery of the flow path limiting member 16 and in a direction opposing the air circulating direction of the a circulating air flow 30. The tip part 58a of the cleaning media guide member 58 is arranged to block the cleaning media discharge outlet 16a when arranged at an open position corresponding to a position during cleaning operations. That is, the tip part 58a of the cleaning media guide member 58 forms a part of the outer peripheral face of the flow path limiting member 16 in this case.

In this way, during cleaning operations, the cleaning media 5 that are being flown and circulated may be prevented from entering the cleaning media discharge outlet 16a and cleaning medium flying operations may be prevented from being disrupted by the cleaning media discharge outlet 16a. By rotating the dust collection duct 56 to move the cleaning media guide member 58 in and out of the cleaning media discharge outlet 16a, an operation mode may be arbitrarily switched between cleaning mode for performing cleaning operations and discharge mode for discharging the cleaning media.

Referring to FIGS. 4 and 5, in the cleaning mode, the dust collection duct 56 is rotated in the direction indicated by arrow R2 to move the cleaning media guide member 58 from a discharge position (see FIG. 1) to the open position at which the cleaning media guide member 58 fits into the cleaning media discharge outlet 16a. In this open position, the cleaning media guide member 58 may be prevented from blocking the circulating flow path 60 and disrupting the circulating air flow 30. Thus, the cleaning media 5 may fly smoothly within the chassis 50 to clean the cleaning object 20.

Although not shown, position markers indicating the positions corresponding to the open position and the discharge position of the cleaning media guide member 58 may be arranged on the outer peripheral face of the chassis body 52 in order to facilitate the rotating operation of the dust collection duct 56.

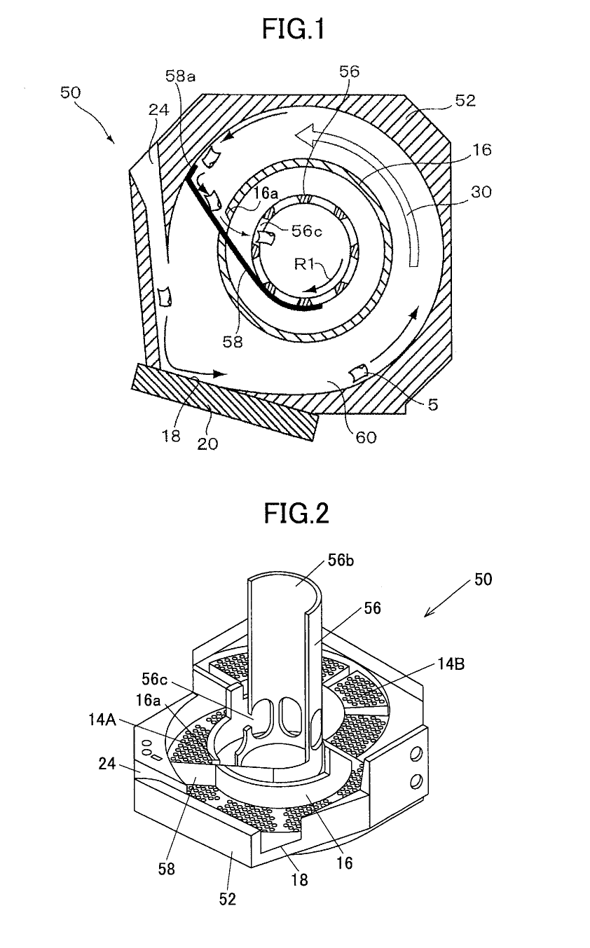

Referring to FIGS. 1 and 2, in the discharge mode, the dust collection duct 56 is rotated in the direction indicated by arrow R1 to move the cleaning media guide member 58 from the open position to the discharge position at which the cleaning media guide member 58 protrudes out from the cleaning media discharge outlet 16a to block the circulating flow path 60.

When the cleaning media guide member 58 is arranged at the discharge position, the cleaning media guide member 58 blocks the circulating air flow 30 and causes the air flow to abruptly change its direction. That is, an air flow that causes air to flow from the circulating path 60 to the dust collection duct 56 through the cleaning media discharge outlet 16a is generated.

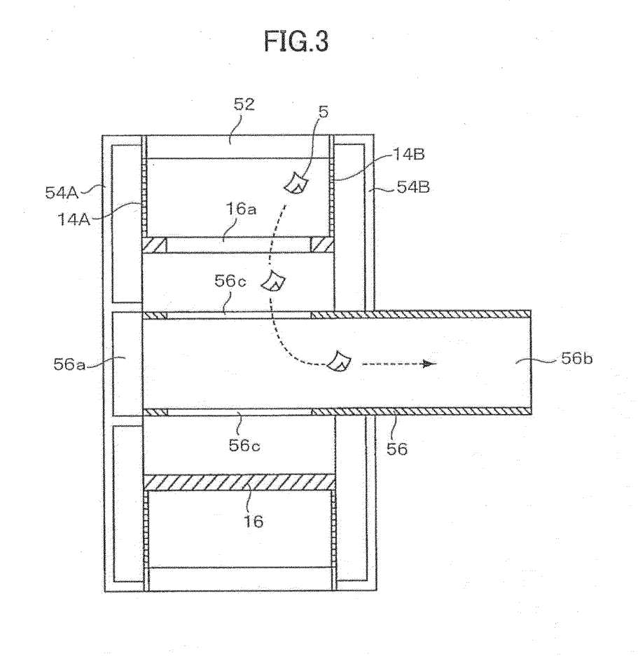

In this case, as illustrated in FIG. 3, the energy action of the circulating air flow 30 causes the cleaning media 5 flying around the circulating flow path 60 to flow from the circulating flow path 60 through the cleaning media guide member 58 and the cleaning media discharge outlet 16a to be guided and discharged to the dust collection duct 56.

By using the energy of the circulating air flow 30 to discharge the cleaning media 5, the cleaning media 5 within the chassis 50 may be quickly discharged.

It is noted that the cleaning media guide member 58 does not necessarily have to block the circulating path 60 completely. That is, an open gap may be formed at the cleaning media guide member 58. In this case, although the overall rate (amount) at which the cleaning media 5 are guided to the cleaning media discharge outlet 16a may decrease, the cleaning media 5 may still be completely discharged taking a longer period of time.

The material of the cleaning media guide member 58 may be any material that is able to resist the circulating motion energy of the cleaning media 5. For example, the cleaning media guide member 58 may be made of a metallic thin film or a resin plate having a plate thickness of no more than several millimeters. Also, in contemplation of being accommodated within the flow path limiting member 16, a material that can resist plastic deformation may preferably be used. In another example, a porous material or a meshed material such as punched metal may be used. In this case, because some of the circulating air flow may pass through the cleaning media guide member 58, resistance against moving the cleaning media guide member 58 in and out of the cleaning media discharge outlet 16a may be reduced and the thickness of the cleaning media guide member 58 may be reduced.

In the cleaning mode, because a centrifugal force is generated to cause substantially all of the cleaning media 5 to circulate around the outer side (chassis side) of the circulating path 60, the cleaning media discharge outlet 16a does not have to be completely blocked. However, the end part of the cleaning media guide member 58 at the side that blocks the circulating path 60 is preferably arranged into a shape that could block the cleaning media discharge outlet 16a as described above.

Also, although the cleaning media guide member 58 and the cleaning media discharge outlet 16a may be arranged at any position along the circulating flow path 60, the cleaning media guide member 58 and the cleaning media discharge outlet 16a are preferably arranged at the circulating direction upstream side of an inlet position (merging position) at which the air entering from the inlet 24 and the circulating air flow 30 merge. Because turbulence flow caused by collision of the air entering the chassis 50 from the inlet 24 with the circulating air flow 30 or the cleaning object 20 is less likely to occur at the circulating direction upstream side of the inlet position, by arranging the cleaning media guide member 58 and the cleaning media discharge outlet 16a at such position, motion of the cleaning media 5 may be less likely to be disrupted so that guidance of the cleaning media 5 may be facilitated and the cleaning media 5 may be efficiently discharged.

It is noted that the means used to move the cleaning media guide member 58 in and out of the cleaning media discharge outlet 16a is not particularly limited. For example, the cleaning media guide member 58 may be moved manually as long as the interior of the chassis 50 may be maintained airtight. In one specific example, the base part of the cleaning media guide member 58 may be fixed to the dust collection duct 56, and the dust collection duct 56 may be arranged to be rotatable to enable position adjustment of the cleaning media guide member 58 while maintaining airtightness of the chassis 50. Because the dust collection duct 56 has one end part corresponding to a suction port protruding out of the chassis 50, this suction port may be rotated from the outside to enable easy switching between the discharge mode and the cleaning mode through a uniaxial motion.

In another example, a torsion spring or the like may be used to urge the dust collection duct 56 to be disposed at a position corresponding to the open position of the cleaning media guide member 58. In this way, a delay in switching from the discharge mode to the cleaning mode may be avoided once new cleaning media are supplied after the old cleaning media in the chassis 50 are discharged. That is, operations may be promptly switched back to cleaning mode even if an operator forgets to readjust the duct collection duct 56 to the position corresponding to the open position. In this case, a force resisting the urging force of the spring may be required to rotate the dust collection duct 56 to the position corresponding to the discharge position. However, because the cleaning media may be quickly (instantly) discharged once the cleaning media guide member 58 is moved to the discharge position, the dust collection duct 56 does not have to be retained at the position corresponding to the discharge position for such a long period of time.

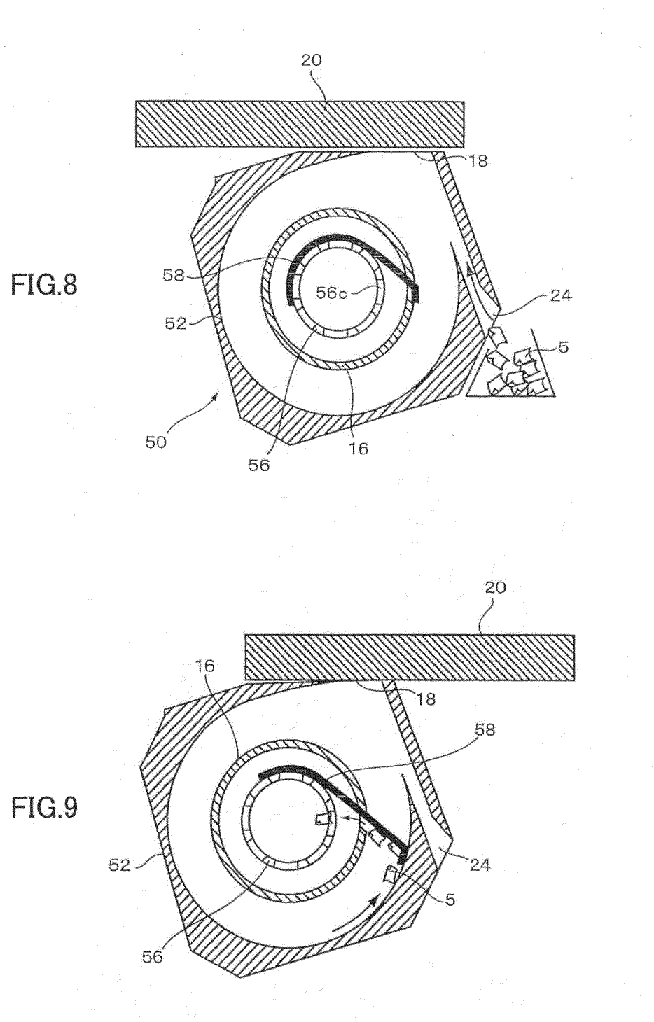

FIGS. 8 and 9 illustrate an exemplary embodiment in which switching between discharge mode and cleaning mode may be performed through a uniaxial rotation operation (rotation of the dust collection duct 56). It is noted that although the opening part 18 of the chassis 50 is arranged to face upward to come into contact with the cleaning object 20 in the illustrated example, the present invention is not limited to such an arrangement.

Referring to FIG. 8, while the cleaning medium guide member 58 is arranged at the open position, the suction unit 6 is operated and the opening part 18 is held in contact with the cleaning object 20 to generate the circulating air 30.

Then, the cleaning medium 5 weighing a predetermined amount is introduced from the inlet 24 and vacuumed into the chassis 50. In this way, cleaning operations may be started.

Referring to FIG. 9, when the cleaning media 5 are to be discharged after the cleaning operations, without separating the opening part 18 from the cleaning object 20, the dust collection duct 56 is rotated to move the cleaning media guide member 58 to the discharge position.

In turn, the cleaning media 5 within the chassis 50 are guided to the dust collection duct 56 from the circulating flow path 60 via the cleaning media guide member 58 to be quickly discharged to the suction unit 6. It is noted that in certain embodiments, operation for supplying the cleaning media 5 to the chassis 50 and/or moving the chassis may be automated.

By repeating the above-described operations, cleaning operations may be continuously performed while refreshing (exchanging) the cleaning media 5.

According to an aspect of the present embodiment, the cleaning media 5 may be quickly discharged when exchanging the cleaning media 5. That is, by performing the exchange operations while the regular circulating air flow 30 is being generated, the cleaning media 5 may be circulating and flying at high speed rather than being electrostatically adhered to the inner side face of the chassis 50 so that the cleaning media 5 within the chassis 50 may be completely discharged.

Further, by discharging the cleaning media 5 while the opening part 18 is blocked; that is, by discharging the cleaning media without moving the opening part 18 away from the cleaning object 20, the used cleaning media 5 may be prevented from scattering from the opening part 18.

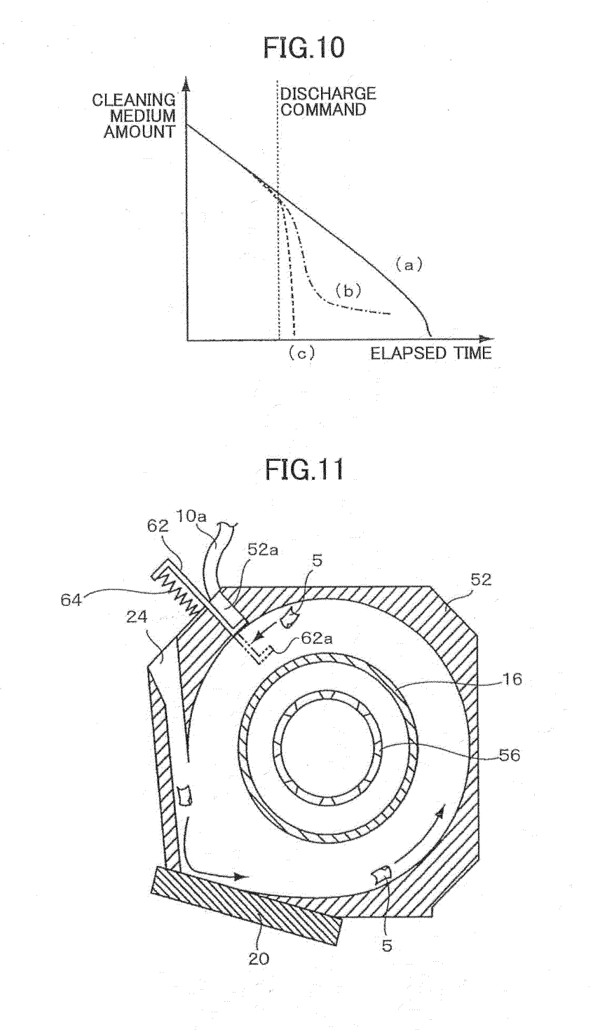

FIG. 10 is a graph representing experimental results obtained from comparing cleaning media discharge operations according to an embodiment of the present invention and cleaning media discharge operations that are conventionally implemented.

The experiment involved monitoring the change in the total weight (amount) of cleaning media within the chassis over time from a state in which the chassis is filled with the cleaning media weighing a predetermined amount, the opening part of the chassis is blocked by a dummy cleaning object, and the dust collection duct is activated.

In the graph of FIG. 10, solid line (a) represents the results of monitoring conventional natural discharge operations in which operations are not actively switched to discharge mode. In this case, with the elapse of time, wearing of the cleaning media occurs during cleaning operations, and bits and pieces of the cleaning media that have been broken off are discharged via the separation plate. In this way, the total weight (amount) of the cleaning media in the chassis gradually decreases. The total amount of the cleaning media abruptly decreases when the cleaning media are worn further to be reduced to a size that is smaller than the mesh size of the separation plate.

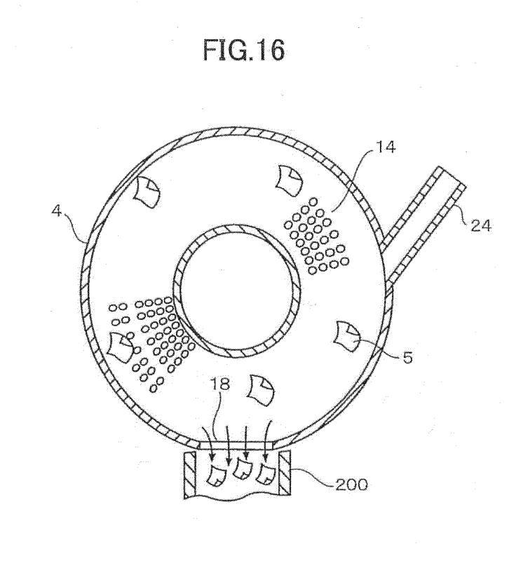

Dot-dashed line (b) in FIG. 10 represents the results of monitoring the cleaning media discharge operations illustrated in FIG. 16 that involves moving the opening part 18 away from the cleaning object 20 and vacuuming the cleaning media out of the chassis 4 via the opening part 18 using the dust collection duct 200. The discharge command indicates the time at which cleaning media discharge operations are started. As can be appreciated, an abrupt decrease in the amount of cleaning media occurs when the cleaning media discharge operations are started and the amount of cleaning media may be reduced to a certain amount. However, as described above, in this example, some cleaning media ultimately remains within the chassis 4 and the cleaning media cannot be completely discharged.

Dashed line (c) in FIG. 10 represents the results of monitoring the cleaning discharge operations of the present embodiment. As can be appreciated, in this example, when discharge operations are started in response to a discharge command, the total weight (amount) of cleaning media decreases at a faster rate than the above two examples and the cleaning media can be completely discharged.

As can be appreciated from the above experimental results, by implementing the cleaning media discharge operations according to the present embodiment, cleaning media may be completely discharged at a faster rate than the conventional discharge operations.

It is noted that although the cleaning media guide member 58 is accommodated inside the flow path limiting member 16 and the cleaning media guide member 58 is arranged to be moved in and out from the inner peripheral side of the circulating flow path 60 in the above-described embodiment, the present invention is not limited to such an arrangement.

For example, in one alternative embodiment (second embodiment) as illustrated in FIG. 11, a cleaning media discharge outlet 52a may be formed at the chassis body 52, and a cleaning media guide member 62 may be arranged to block the cleaning media discharge outlet 52a. In this embodiment, the cleaning media discharge outlet 52a is connected to a suction hose (suction port) 10a that branches out from the suction hose 10 of the suction unit 6.

The cleaning media guide member 62 is urged by a spring member 64 to be disposed at a position corresponding to an open position at which its tip end part 62a blocks the cleaning media discharge outlet 52a. Relying on the characteristic of the cleaning media 5 to fly toward the outer periphery side of the circulating flow path 60 due to centrifugal force, the length of the cleaning media guide member 62 is arranged so that it would block a portion of the circulating flow path 60 at the outer periphery side upon being moved to a discharge position for discharging the cleaning media 5.

FIGS. 12A and 12B illustrate a third embodiment of the present invention. The chassis configuration according to this embodiment is similar to that of the chassis 50 illustrated in FIG. 1 other than that it includes a cleaning media guide member 70 arranged at the chassis body 52 and does not have a rotating member for rotating the dust collection duct 56.

As illustrated in FIG. 12B, the cleaning media guide member 70 is urged by the spring member 64 in the outward direction (indicated by the arrow shown in FIG. 12B) so that its tip end part 70a may be prevented from protruding from the inner face of the chassis body 52.

An outer periphery side air flow 30a of the circulating air flow 30 circulates at a higher peripheral speed compared to an inner periphery side air flow 30b of the circulating air flow 30. As described above, centrifugal force causes the cleaning media 5 to fly toward the outer periphery side of the circulating flow path 60. When the suction unit 6 is in operation, a pulling force “if” is generated in the vicinity of the cleaning media discharge outlet 16a. It is noted that the plural arrows shown in FIG. 12B represent the air flow of air being vacuumed into the interior of the dust collection duct 56 when the suction unit 6 is in operation (illustrations of such air flow are omitted in the other drawings).

In cleaning mode, the cleaning media guide member 70 is arranged to be accommodated within the chassis body 52 as illustrated in FIG. 12B. Because centrifugal force causes the cleaning media 5 to fly toward the outer periphery side of the circulating flow path 60, the cleaning media 5 may not be discharged even if the cleaning media discharge outlet 16a is not blocked. It is particularly noted that by arranging the cleaning media discharge outlet 16a toward the circulating direction upstream side of the inlet position (merging position), a disruption in the motion of the cleaning media may be prevented from occurring and discharge of the cleaning media during cleaning operations may be effectively prevented. That is, in a case where the cleaning media discharge outlet 16a is positioned close to a merging point “m” where the air flow of air entering from the inlet 24 (inlet air flow) merges with the circulating air flow 30, the cleaning media that are bounced off by the inlet air flow may be pushed back toward the circulating direction upstream side. The cleaning media that are pushed back may then be pulled into the cleaning media discharge outlet 16a by the pulling flow “if”. However, by arranging the cleaning media discharge outlet 16a to be positioned at the circulating direction upstream side of the merging point “m”, undesired discharge of the cleaning media 5 may be prevented.

In discharge mode, the cleaning media guide member 70 may be directly pushed so that it protrudes from the inner face of the chassis body 52 to block the circulating flow path 60 as illustrated in FIG. 12A. The cleaning media guide member 70 is arranged in a suitable direction for guiding the cleaning media 5 toward the cleaning media discharge outlet 16a.

When the cleaning media guide member 70 is pushed out, the direction of the outer periphery side air flow 30a of the circulating air flow 30 is abruptly changed and the cleaning media 5 is guided and discharged to the dust collection duct 56 from the circulating flow path 60 via the cleaning media guide member 70 and the cleaning media discharge outlet 16a.

Because the outer periphery side air flow 30a flows at a higher peripheral speed than the inner periphery side air flow 30b as described above, the energy of the outer periphery side air flow 30a moving the cleaning media 5 toward the cleaning media discharge outlet 16a overpowers the energy of the inner periphery side air flow 30b. That is, this energy combined with the action of the pulling flow “if” moves the cleaning media 5 toward the cleaning media discharge outlet 16a and into the dust collection duct 56.

Because centrifugal force causes the cleaning media 5 to fly toward the outer periphery side of the circulating flow path 60, the cleaning media guide member 70 does not necessarily have to completely block the circulating flow path 60. That is, an open gap may be formed at the cleaning guide member 70. In such a case, although the amount of the cleaning media 5 guided to the cleaning media discharge outlet 16a may be reduced, the cleaning media 5 may still be completely discharge taking a longer period of time.

According to one aspect of the present embodiment, the amount of cleaning media discharged may be controlled by adjusting the time period during which the cleaning media guide member 70 is pushed. That is, the amount of cleaning media to be refreshed (exchanged) during cleaning operations may be controlled. It is noted that the means used to move the cleaning media guide member 70 in and out (back and forth from the outer periphery side to the inner periphery side of the circulating flow path 60) is not particularly limited. The cleaning media guide member 70 may be moved automatically or manually, for example.

Table 1 shown below indicates experimental results obtained from comparing the discharge times of cleaning media discharge operations performed with the cleaning media guide member 70 protruding at different protruding distances (i.e., distance of the part of the cleaning media guide member 70 protruding from the circulating flow path 60 upon being pushed).

TABLE 1

| Protruding Distance | Discharge Time |
|---|---|
| 0 mm | 530 sec |
| 5 mm | 12 sec |
| 10 mm | 5 sec |
| 20 mm | 1 sec or less |

The experiment involved monitoring the change in the total weight (amount) of cleaning media over time from a state in which the chassis is filled with cleaning media weighing a predetermined amount, the opening part 18 is sealed by a dummy cleaning object, and the dust collection duct is activated.

It is noted that in the present experiment, the distance between the inner periphery and the outer periphery of the circulating flow path 60 was 20 mm.

The above result obtained from the case where the protruding distance was 0 mm represents the result of natural discharge operations. In this case, the discharge time represents the time it took for the cleaning media to be reduced to a size smaller than the mesh size of the separation plate (530 sec).

In the case where the protruding distance was 5 mm, discharge operations for completely discharging the cleaning media 5 took 12 seconds, which is substantially faster than the case where natural discharge operations were implemented.

In the case where the protruding distance was 10 mm, discharge operations for completely discharging the cleaning media 5 took 5 seconds.

In the case where the protruding distance was 20 mm; namely, when the circulating flow path 60 was completely blocked, discharge operations for completely discharging the cleaning media 5 took 1 second or less. Considering the time required for moving the cleaning media guide member 70, the above discharge time represents a nearly instant discharge of the cleaning media 5.

As can be appreciated from the above, according to an aspect of the present embodiment, cleaning media may be completely discharged in a short period of time.

Further, the present invention is not limited to the above-described embodiments, and numerous variations and modifications may be made without departing from the scope of the present invention.

The present application is based on and claims the benefit of priority of Japanese Patent Application No. 2012-162911 filed on Jul. 23, 2012, and Japanese Patent Application No. 2012-285054 filed on Dec. 27, 2012, the entire contents of which are hereby incorporated by reference.

What is claimed is:

1. A dry-type cleaning chassis that is configured to clean a cleaning object by causing cleaning media to be flown by an air flow and causing the cleaning media to come into contact with the cleaning object, the dry-type cleaning chassis comprising:
an internal space in which the cleaning media are flown;
an opening part configured to be in contact with the cleaning object so that the cleaning media collide with the cleaning object;
an air inlet duct configured to introduce external air into the internal space;
a suction port that vacuums the air introduced into the internal space from the air inlet duct and causes a circulating air flow to be generated in the internal space;
a flow path limiting member that regulates a circulating axis of the circulating air flow within the internal space;
a cleaning media discharge outlet that is in communication with an exterior of a circulating flow path of the circulating air flow and is configured to discharge the cleaning media from the circulating flow path to the exterior; and
a cleaning media guide member that guides the cleaning media to the cleaning media discharge outlet.

2. The dry-type cleaning chassis as claimed in claim 1, wherein
the cleaning media guide member is configured to be arbitrarily adjustable to a discharge position at which the cleaning media guide member blocks at least a portion of the circulating flow path and guides the cleaning media to the cleaning media discharge outlet and an open position at which the cleaning media guide member leaves the circulating flow path open.

3. The dry-type cleaning chassis as claimed in claim 1, wherein
the cleaning media guide member is arranged into a shape that blocks the cleaning media discharge outlet when the cleaning guide member is disposed at a position that leaves the circulating flow path open.

4. The dry-type cleaning chassis as claimed in claim 1, wherein
the cleaning media guide member is arranged at a circulating direction upstream side of a merging position at which the air introduced from the air inlet duct merges with the circulating air flow.

5. The dry-type cleaning chassis as claimed in claim 1, wherein
the cleaning media discharge outlet is arranged at the flow path limiting member and an interior of the flow path limiting member is arranged to be in communication with the suction port.

6. The dry-type cleaning chassis as claimed in claim 5, wherein
the cleaning media guide member is accommodated within the flow path limiting member.

7. The dry-type cleaning chassis as claimed in claim 6, wherein
a rotatable member is arranged at the interior of the flow path limiting member; and
the rotatable member is rotated to adjust the cleaning media guide member to a discharge position at which the cleaning media guide member blocks at least a portion of the circulating flow path and guides the cleaning media to the cleaning media discharge outlet and an open position at which the cleaning media guide member leaves the circulating flow path open.

8. The dry-type cleaning chassis as claimed in claim 1, wherein
the cleaning media guide member is configured to be movable back and forth from an outer periphery side of the circulating flow path to an inner periphery side of the circulating flow path.

9. The dry-type cleaning chassis as claimed in claim 1, further comprising:
a porous unit that is configured to pass removed matter that is removed from the cleaning object to the suction port side.

10. A dry-type cleaning device comprising:
cleaning media for cleaning a cleaning object;
a suction unit that is connected to a suction port; and
a dry-type cleaning chassis that is configured to clean the cleaning object by causing the cleaning media to be flown by an air flow and causing the cleaning media to come into contact with the cleaning object, the dry-type cleaning chassis including
an internal space in which the cleaning media are flown;
an opening part configured to be in contact with the cleaning object so that the cleaning media collide with the cleaning object;
an air inlet duct configured to introduce external air into the internal space;
the suction port that vacuums the air introduced into the internal space from the air inlet duct and causes a circulating air flow to be generated in the internal space;
a flow path limiting member that regulates a circulating axis of the circulating air flow within the internal space;
a cleaning media discharge outlet that is in communication with an exterior of a circulating flow path of the circulating air flow and is configured to discharge the cleaning media from the circulating flow path to the exterior; and
a cleaning media guide member that guides the cleaning media to the cleaning media discharge outlet.

11. A dry-type cleaning method for cleaning a cleaning object, the method comprising the steps of:
placing an opening part of a chassis in contact with the cleaning object to block the opening part and vacuuming air within the chassis;
causing external air to flow into the chassis via an air inlet duct that is arranged at the chassis and causing a circulating air flow to be generated within the chassis;
causing cleaning media that are flown by the circulating air flow within the chassis to collide with the cleaning object at the opening part; and
discharging the cleaning media within the chassis during cleaning operations by blocking at least a portion of a circulating flow path of the circulating air flow with a cleaning media guide member and guiding the cleaning media to a cleaning media discharge outlet that is in communication with an exterior of the circulating flow path and is configured to discharge the cleaning media from the circulating flow path.
